(19) United States
(12) Patent Application Publication
(10) Pub. No.: US 2026/0303511 A1
(43) Pub. Date: Oct. 1, 2026

(54) BGP Route Filtering Using Peer Tags

(71) Applicant: Arista Networks, Inc., Santa Clara, CA (US)

(72) Inventors: Jesper SKRIVER, Latsia (CY); Qing YANG, Cupertino, CA (US); Vipul SHAH, Santa Clara, CA (US)

(21) Appl. No.: 19/094,150

(22) Filed: Mar. 28, 2025

(51) Int. Cl. H04L 45/02

(52) U.S. Cl. CPC H04L 45/04

(57) ABSTRACT

Techniques for implementing Border Gateway Protocol (BGP) routing filtering using peer tags are provided. In one set of embodiments, a BGP speaker can identify a BGP route to be advertised to an outbound BGP peer, determine one or more inbound peer tags associated with an inbound BGP peer, and determine one or more outbound peer tags associated with the outbound BGP peer. The BGP speaker can then perform one or more comparisons between the one or more inbound peer tags and the one or more outbound peer tags and based on the comparisons, can allow or deny advertisement of the BGP route to the outbound BGP peer.

### BACKGROUND

Border Gateway Protocol (BGP) is a networking protocol that enables network devices to exchange NLRI (Network Layer Reachability Information) with each other. A network device that implements BGP is known as a BGP speaker and BGP speakers that transmit (i.e., advertise) NLRI to each other are known as BGP peers. The reachability information takes the form of one or more BGP routes, where each BGP route is an NLRI received from a single BGP peer, along with a set of BGP attributes that influence in various ways how this particular NLRI might be used.

In some network topologies, it is beneficial for a BGP speaker to filter its “outbound” BGP routes, or in other words the BGP routes eligible for advertisement to BGP peers. This filtering process denies or allows the transmission of certain BGP routes to certain BGP peers based on user-defined filtering criteria. However, existing mechanisms for implementing BGP route filtering are generally difficult and/or cumbersome to configure.

### BRIEF DESCRIPTION OF THE DRAWINGS

With respect to the discussion to follow and in particular to the drawings, it is stressed that the particulars shown represent examples for purposes of illustrative discussion and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. Similar or same reference numbers may be used to identify or otherwise refer to similar or same elements in the various drawings and supporting descriptions. In the accompanying drawings:

FIG. 1 depicts a first example network in accordance with certain embodiments of the present disclosure.

FIG. 2 depicts a second example network in accordance with certain embodiments of the present disclosure.

FIGS. 3 and 4 depict a first set of workflows in accordance with certain embodiments of the present disclosure.

FIGS. 5 and 6 depict a second set of workflows in accordance with certain embodiments of the present disclosure.

FIGS. 7 and 8 depict a third set of workflows in accordance with certain embodiments of the present disclosure.

FIG. 9 depicts an example BGP speaker in accordance with certain embodiments of the present disclosure.

### DETAILED DESCRIPTION

In the following description, for purposes of explanation, numerous examples and details are set forth in order to provide an understanding of embodiments of the present disclosure. Particular embodiments as expressed in the claims may include some or all of the features in these examples, alone or in combination with other features described below, and may further include modifications and equivalents of the features and concepts described herein.

Embodiments of the present disclosure are directed to a framework for implementing outbound BGP route filtering via peer tags, referred to as the peer tag filtering (PTF) framework. A “peer tag” is a label, such as an alphanumeric string or a number, that is assigned to one or more BGP peers. In certain embodiments, the PTF framework involves receiving, on a BGP speaker, assignments of peer tags to the BGP peers of the speaker and configurations of PTF policies, where each PTF policy includes peer tag comparison logic. The framework further involves processing, by the BGP speaker, an outbound BGP route by (1) determining one or more inbound peer tags assigned to an inbound BGP peer from which the route was received, (2) determining one or more outbound peer tags assigned to an outbound BGP peer to which the route may be advertised, and (3) executing one or more comparisons of the inbound and outbound peer tags in accordance with a configured PTF policy. Based on the results of these comparisons, the BGP speaker can either deny or allow the advertisement of the route to the outbound peer.

As explained below, the PTF framework can be applied to solve various problems arising out of the unregulated advertisement of BGP routes while being easier to configure than existing BGP route filtering mechanisms.

### 1. Example Network Topologies

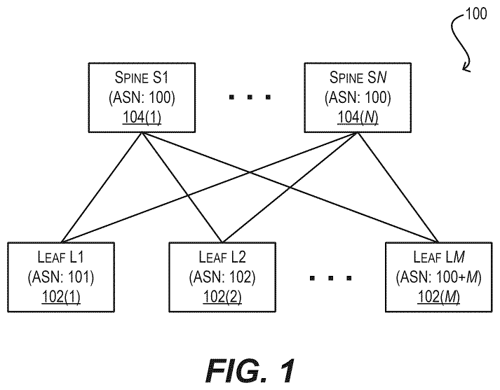

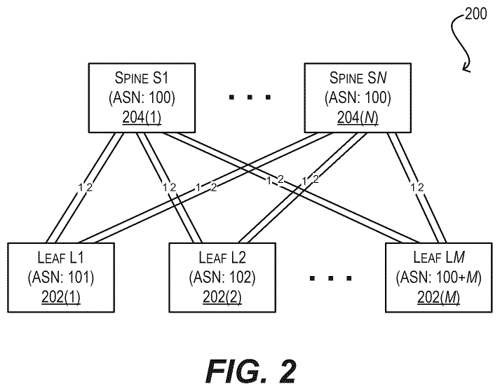

To provide context for the PTF framework the present disclosure, FIGS. 1 and 2 depict two example leaf-spine networks 100 and 200 that exhibit problems which can be addressed by the framework.

Starting with FIG. 1, leaf-spine network 100 comprises M leaf network devices (i.e., leaves) L1-LM (reference numerals 102(1)-(M)) that are connected via singular physical links to N spine network devices (i.e., spines) S1-SN (reference numerals 104(1)-(N)). Each leaf/spine is a BGP speaker that runs the BGP protocol. Further, each leaf is an external BGP (eBGP) peer of each spine, which means that the leaves and the spines exchange BGP routes across different autonomous systems (ASs). This is due to the fact that spines S1-SN are part of one AS (identified by AS number (ASN) 100) and each leaf is part of another AS different from the spines'AS (e.g., L1 is part of ASN 101, L2 is part of ASN 102, and so on).

Per the conventional rules of eBGP route advertisement, a BGP route that is received by a BGP speaker from one eBGP peer should be advertised by that speaker to all of its other eBGP peers. Accordingly, if one leaf (e.g., L1) advertises a BGP route R to spines S1-SN, each spine will thereafter advertise route R to the other leaves L2-LM. Further, for each instance of route R received from a spine, each receiving leaf (L2-LM) will thereafter advertise R back to the other spines, if the leaf selects the path specified by the parameters in the route as the best path to the route's NLRI. This results in a scenario where every spine receives up to (N−1)*M copies of route R, which is inefficient because only a single copy is needed at each spine.

It should be noted that, upon receiving a copy of route R that previously passed through one of the spines, each spine will typically drop that copy due to an AS-path loop check mechanism; this is an existing BGP feature that prevents a route from looping back to the same AS it came from. However, each spine must still devote central processing unit (CPU) resources towards executing the AS-path loop check on each received copy of R, which can adversely affect the spine's processing of other, valid BGP routes.

Turning now to leaf-spine network 200 of FIG. 2, this network is similar to network 100 of FIG. 1 in that it comprises M leaves L1-LM (reference numerals 202(1)-(M)) and N spines S1-SN (reference numerals 204(1)-(N)), where each leaf/spine is a BGP speaker and where the spines reside in a different AS than the leaves (thereby indicating eBGP peerings). However, unlike network 100, each leaf-spine pair in network 200 is connected via multiple (K) equal-cost physical links for load balancing purposes, rather than a single physical link. Specifically, in network 200 there are two links per leaf-spine pair (or in other words, K=2), where the first link is numbered “1” and the second link is numbered “2”.

With this type of multi-link topology, each physical link between a leaf and a spine is typically associated with a separate eBGP peering session. Thus, each physical link represents a connection to a separate logical eBGP peer. Further, each leaf Li has K*N equal-cost paths for reaching every other leaf. Accordingly, at the time of sending network traffic to another leaf Lj, leaf Li will load balance the traffic across the K*N physical links it has to the spines. Each spine will then receive 1/N of the total traffic from leaf Li and load balance that received traffic across the K physical links it has to destination leaf Lj.

With the foregoing in mind, consider a scenario where a link between a particular leaf-spine pair fails, such as between leaf L3 and spine S2. In this scenario, L3 and S2 will detect the link failure and use the remaining K−1 operational links between them to continue exchanging traffic. However, the problem here is that the other leaves and spines in network 200 will not be aware of the link failure and will continue to operate as if the topology is fully intact. For example, if leaf L1 subsequently sends network traffic to leaf L3, L1 will load balance that traffic across the K*N links it has to spines S1-SN, even though the bandwidth between spine S2 and leaf L3 is now degraded due to the failed link. As a result, the load on the remaining K−1 operational links between S2 and L3 will increase, which can result in degraded performance (for example, if S2 and L3 need to throttle traffic on the K−1 operational links due to the increased load).

This issue is particularly severe in leaf-spine network deployments that are used for graphics processing unit (GPU) workloads (where the GPUs are connected to the leaves) because such workloads often operate in cycles and rely on receiving information back from all other GPUs before they can proceed to the next cycle. For instance, in a scenario where there are four leaves L1-L4, four spines S1-S4, and two physical links between each leaf-spine pair, the failure of a single link between, e.g., S2 and L3 can cause a 50% slowdown in a GPU workload due to the 50% reduction in bandwidth between S2 and L 3, even though the actual total bandwidth loss in the network is only 12.5% (due to the loss of one out of eight possible paths between L3 and every other leaf).

### 2. Solution Overview

One commonality between the two problems described with respect to networks 100 and 200 above is that both problems can be solved via BGP route filtering, or in other words by blocking certain outbound BGP routes from being advertised to certain BGP peers. For the problem in network 100 (hereinafter referred to as “problem A”), the solution generally entails blocking each leaf from advertising a BGP route to a spine if that route was received from a spine. And for the problem in network 200 (hereinafter referred to as “problem B”), the solution generally entails blocking a spine Si that has experienced a failure on the k-th link to a leaf Lj from advertising the BGP routes previously received from Lj on that now failed link to other leaves via the k-th link connecting those other leaves. This will cause the other leaves to no longer use its k-th link to spine Si for sending traffic to leaf Lj, resulting in a rebalancing of traffic across the remaining K*N−1 operational paths to Lj.

However, as noted previously, existing mechanisms for implementing BGP route filtering are difficult and/or cumbersome to configure. For example, with respect to solving problems A and B, several of these existing mechanisms require complex configurations on both the spines and the leaves.

To address these limitations, the PTF framework of the present disclosure enables BGP route filtering via a novel and straightforward peer tag mechanism. At a high level, the PTF framework comprises two phases: configuration and filtering. During the configuration phase, a BGP speaker that implements the framework receives (from, e.g., a user or an automated agent) assignments of peer tags to the BGP peers of the speaker, as well as configurations of PTF policies. Each PTF policy may be configured for a specific BGP peer, a subset of BGP peers, or on a global basis (such that it applies to all BGP peers) and includes peer tag comparison logic.

Then, during the filtering phase (which is executed by the BGP speaker during outbound BGP route advertisement processing), the BGP speaker identifies an outbound BGP route R to be advertised to an outbound BGP peer P, determines one or more inbound peer tags assigned to an inbound BGP peer from which R was received, determines one or more outbound peer tags assigned to P, and executes one or more comparisons of the inbound and outbound peer tags in accordance with a configured PTF policy. Based on the results of these comparisons, the BGP speaker either denies or allows the advertisement of route R to outbound peer P.

With this general design, a number of benefits are realized. First, because the PTF framework involves relatively uncomplicated peer tag and PTF policy configurations, this framework enables users and network administrators to solve problems A and B noted above more easily than existing BGP routing filtering mechanisms. Second, the PTF framework can be flexibly adapted to solve other types of problems or achieve other types of goals that involve BGP route filtering by customizing the peer tag assignments and/or the peer tag comparison logic included in the PTF policies.

The remaining sections of the present disclosure present example workflows for implementing the PTF framework according to various embodiments, including workflows for specifically addressing problems A and B.

### 3. Generic Workflows

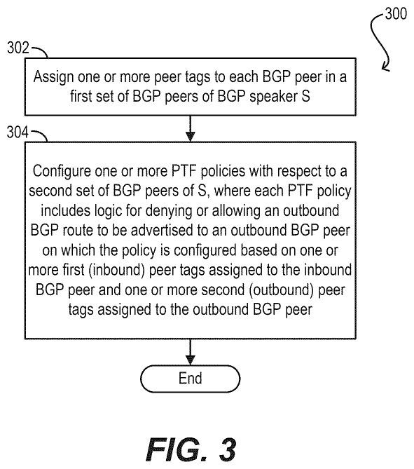

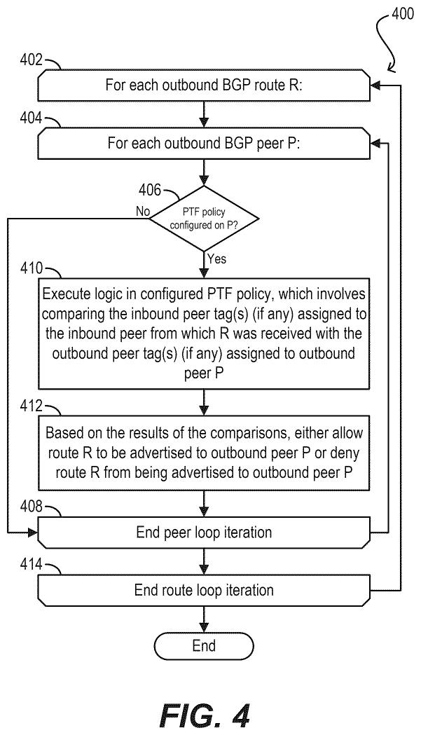

FIGS. 3 and 4 depict workflows 300 and 400 for implementing the PTF framework generically, or in other words in a manner that leaves the peer tag assignments and the content of the PTF policies open-ended (so that they can be customized as needed to address specific use cases). In particular, workflow 300 is a configuration workflow that may be executed by, e.g., a user/administrator or an automated agent (referred to as “the configurator”) for configuring the framework on a BGP speaker S and workflow 400 is a filtering workflow that may be executed by, e.g., the BGP control plane of S during outbound BGP route advertisement processing to filter outbound BGP routes in accordance with the configurations made via workflow 300. In certain embodiments, workflow 400 can be performed at a relatively early stage of the outbound BGP route advertisement processing task, such as before the handling of any other (non-PTF) outbound policies. This advantageously reduces CPU usage on speaker S because those other non-PTF outbound policies can be entirely avoided for any outbound BGP routes that are blocked from being advertised by the PTF framework.

Starting with workflow 300, at step 302, the configurator can assign one or more peer tags to each BGP peer in a first set of BGP peers of speaker S. As mentioned previously, each peer tag is a label, such as an alphanumeric string or a number. In various embodiments, a peer tag that is assigned to a given BGP peer can be unique to that peer or can be shared by (assigned to) multiple BGP peers.

At step 304, the configurator can configure one or more PTF policies with respect to a second of BGP peers of speaker S, which may be the same as, overlap with, or be completely different from the first set of peers. Each of these PTF policies includes logic for denying or allowing an outbound BGP route to be advertised to an outbound BGP peer on which the policy is configured based on one or more first (inbound) peer tags assigned to the inbound BGP peer from which the route was originally received and one or more second (outbound) peer tags assigned to the outbound peer.

Turning now to workflow 400, at step 402, speaker S can enter a first loop for each outbound BGP route R that is eligible for advertisement to S's BGP peers. Further, at step 404, speaker S can enter a second loop for each outbound BGP peer P that is a potential recipient of route R.

Within the second loop, speaker S can check whether there is a PTF policy configured on/for outbound peer P (step 406). If the answer is no, speaker S can proceed to the end of the current loop iteration of the second loop (step 408).

However, if the answer at step 406 is yes (i.e., there is a PTF policy configured on/for outbound peer P), speaker S can execute the logic included in the configured PTF policy with respect to route R and outbound peer P (step 410). As mentioned previously, this logic comprises comparing the inbound peer tag(s) (if any) assigned to the inbound BGP peer from which route R was received against the outbound peer tag(s) (if any) assigned to outbound peer P. Based on the results of these comparisons, speaker S either allows route R to be advertised to outbound peer P or denies/blocks R from being advertised to P (step 412) and reaches the end of the current loop iteration of the second loop.

Upon processing all outbound BGP peers and completing the second loop, speaker S can reach the end of the current loop iteration for the first loop (step 414) and proceed to the next outbound BGP route. Finally, upon processing all outbound BGP routes and completing the first loop, speaker S can terminate the workflow.

### 4. Workflows for Solving Problem A

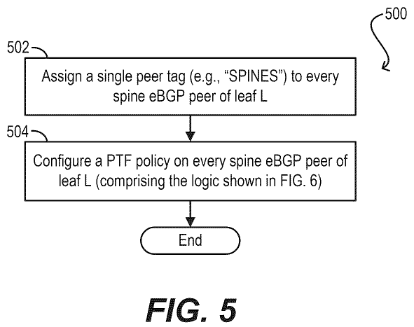

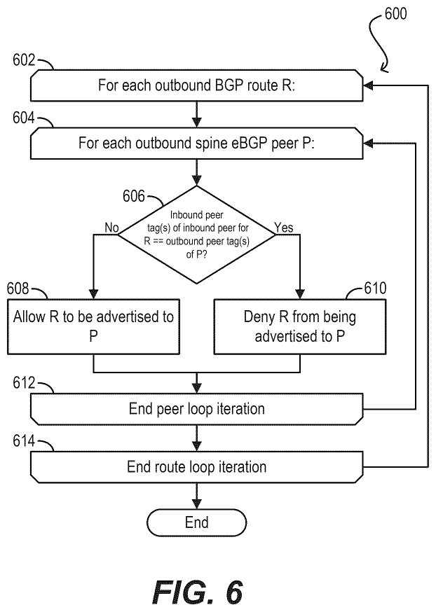

FIGS. 5 and 6 depict workflows 500 and 600 for implementing the PTF framework in a manner that specifically solves problem A described with respect to leaf-spine network 100 of FIG. 1. In particular, workflow 500 is a version of configuration workflow 300 of FIG. 3 that has been modified for this purpose and workflow 600 is a version of filtering workflow 400 of FIG. 4 that has been modified for this purpose. Both configuration workflow 500 and filtering workflow 600 are executed on/by each leaf L in leaf-spine network 100.

Starting with workflow 500, at step 502, a configurator can assign a single peer tag (e.g., “SPINES”) to every spine eBGP peer of leaf L.

At step 504, the configurator can configure a PTF policy on every spine eBGP peer of leaf L, where the configured PTF policy includes logic that is shown in FIG. 6 and described below.

Turning now to workflow 600, at step 602, leaf L can enter a first loop for each outbound BGP route R. Further, at step 604, leaf L can enter a second loop for each outbound spine eBGP peer P that is a potential recipient of route R.

Within the second loop, leaf L can execute the logic included in the PTF policy configured on spine peer P at step 504 of workflow 500, which comprises checking whether the outbound peer tag(s) assigned to P are identical to the inbound peer tag(s) assigned to the inbound spine peer from which route R was received (step 606). If the answer is no, leaf L can allow route R to be advertised to spine peer P (step 608). On the other hand, if the answer is yes, leaf L can deny/block route R from being advertised to spine peer P (step 610). Leaf L can then reach the end of the current loop iteration (step 612) of the second loop and proceed to the next spine peer.

Upon processing all spine peers and completing the second loop, leaf L can reach the end of the current loop iteration for the first loop (step 614) and proceed to the next outbound BGP route. Finally, upon processing all outbound BGP routes and completing the first loop, leaf L can terminate the workflow.

The solution embodied by workflows 500 and 600 prevents each leaf L in leaf-spine network 100 from sending to the spines any BGP route that was received from a spine, thereby avoiding the scenario where each spine receives multiple redundant route copies.

### 5. Workflows for Solving Problem B

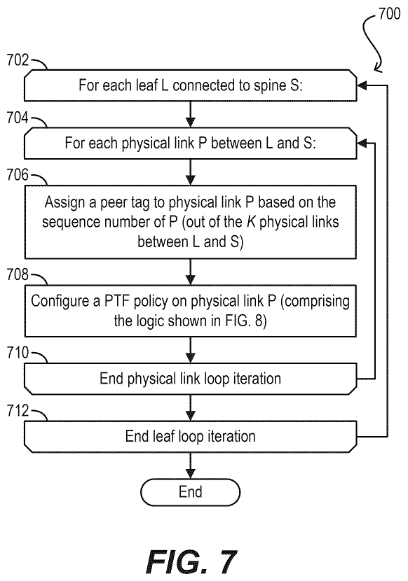

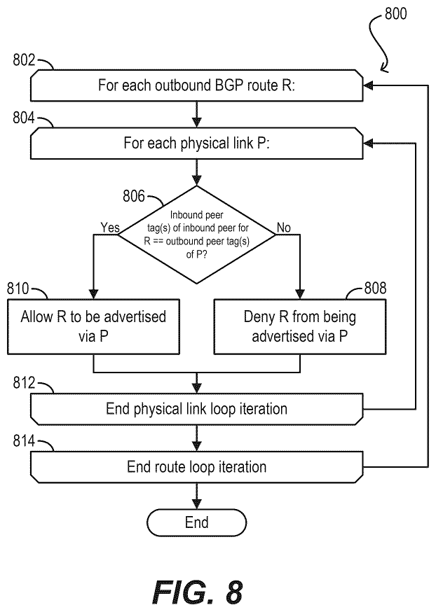

FIGS. 7 and 8 depict workflows 700 and 800 for implementing the PTF framework in a manner that specifically solves problem B described with respect to leaf-spine network 200 of FIG. 2. In particular, workflow 700 is a version of configuration workflow 300 of FIG. 3 that has been modified for this purpose and workflow 800 is a version of filtering workflow 400 of FIG. 4 that has been modified for this purpose. Both configuration workflow 700 and filtering workflow 800 are executed on/by each spine S in leaf-spine network 200.

Starting with workflow 700, at steps 702 and 704, a configurator can enter a first loop for each leaf L to which spine S is connected and a second loop for each physical link P between L and S. Recall that there are K physical links between each leaf-spine pair in network 200 that represent K separate eBGP peering sessions.

At step 706, the configurator can assign a peer tag to physical link P based on the sequence number of P (within the set of K links). For example, if physical link P is the i-th link between leaf L and spine S, it will be assigned a peer tag based on the sequence number i, such that the i-th physical link between all leaf-spine pairs in network 200 are assigned the same peer tag.

In addition, the configurator can configure a PTF policy on physical link P comprising logic that is shown in workflow 800 and described below (step 708).

The configurator can then reach the end of the current loop iteration (step 710) of the second loop and proceed to the next physical link.

Upon processing all physical links between leaf L and spine S and completing the second loop, the configurator can reach the end of the current loop iteration for the first loop (step 712) and proceed to the next leaf. Finally, upon processing all leaves and completing the first loop, workflow 700 can end.

Although not shown in workflow 700, in certain embodiments the configuration phase can further include the steps of enabling the BGP “additional-paths-send” feature on all spines in network 200 and enabling the BGP “additional-paths-receive” feature on all leaves in network 200. These are existing BGP functionalities described in Request for Comments (RFC) 7911 that, when enabled, ensure each spine will attempt to advertise all K paths it is aware of for a given NLRI to its eBGP peers, rather than solely the best path.

Turning now to workflow 800, at step 802, spine S can enter a first loop for each outbound BGP route R. Further, at step 804, spine S can enter a second loop for each physical link P on which route R may be advertised.

Within the second loop, spine S can execute the logic included in the PTF policy configured at step 708 of workflow 700, which comprises checking whether the outbound peer tag(s) assigned to P are identical to the inbound peer tag(s) assigned to the inbound physical link from which route R was received (step 806). If the answer is no, spine S can deny/block route R from being advertised via physical link P (step 808). On the other hand, if the answer is yes, spine S can allow route R to be advertised via physical link P (step 810). Spine S can then reach the end of the current loop iteration (step 812) of the second loop and proceed to the next physical link.

Upon processing all physical links and completing the second loop, spine S can reach the end of the current loop iteration for the first loop (step 814) and proceed to the next outbound BGP route. Finally, upon processing all outbound BGP routes and completing the first loop, spine S can terminate the workflow.

The solution embodied by workflows 700 and 800 ensures that, whenever a physical link between a spine Si and a leaf Lj that is assigned a particular peer tag T goes down, Si will refrain from advertising the BGP routes received from Lj over that failed link via other physical links/eBGP peering sessions assigned the same peer tag T. This will cause the routes from Lj to be withdrawn at the leaves connected to those other physical links/peering sessions, which will in turn prevent those leaves from using those links for sending traffic to Lj. The end result is that the load on the remaining K−1 operational links between spine Si and leaf Lj will not significantly increase after the link failure (because every other leaf will reduce the amount of Lj-destined traffic it sends to Si), thereby avoiding problem B.

### 6. Example BGP Speaker

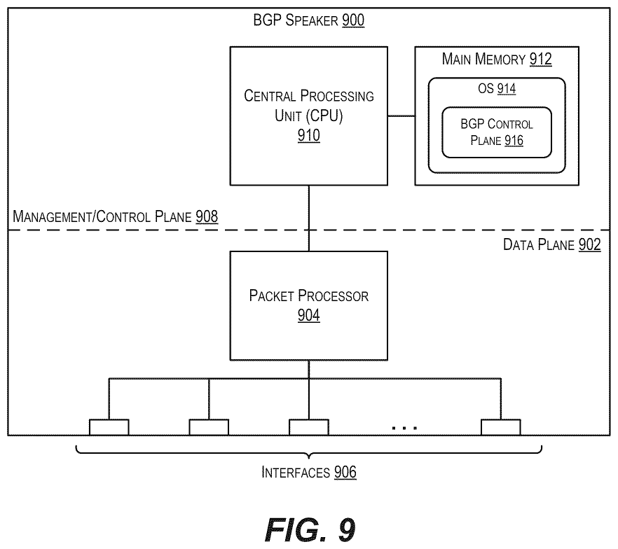

FIG. 9 is a simplified block diagram illustrating the architecture of an example BGP speaker 900 according to certain embodiments. This architecture may be employed by any of the BGP speakers described in the foregoing disclosure, including the leaves and spines of networks 100 and 200.

As shown in FIG. 9, BGP speaker 900 comprises a data (or forwarding) plane 902 including a packet processor 904 and a set of front-panel interfaces (ports) 906. Packet processor 904 is typically an integrated circuit, such as an application-specific integrated circuit (ASIC) or a field-programmable gate array (FPGA), that is responsible for performing line-speed processing of network packets that pass through BGP speaker 900 via interfaces 906. This line-speed processing can include, for example, Layer 3 (L3) routing of IP traffic.

BGP speaker 900 also comprises a management/control plane 908 including a central processing unit (CPU) 910 and a main memory 912. CPU 910 is a general-purpose processor that is responsible for managing the configuration/operation of BGP speaker 900 and controlling the device's understanding of the network in which it resides. CPU 910 carries out these functions under the direction of an operating system (OS) 914 that runs on CPU 910 from main memory 912. Because BGP speaker 900 is a BGP-enabled network device, OS 914 includes a BGP control plane component 916 that allows BGP speaker 900 to run the BGP protocol. In certain embodiments, some or all of the workflows described in the foregoing disclosure may be implemented as software (i.e., program code) that is part of BGP control plane component 916 and executable by CPU 910.

The above description illustrates various embodiments of the present disclosure along with examples of how aspects of these embodiments may be implemented. The above examples and embodiments should not be deemed to be the only embodiments and are presented to illustrate the flexibility and advantages of the present disclosure as defined by the following claims. For example, although certain embodiments have been described with respect to particular workflows and steps, it should be apparent to those skilled in the art that the scope of the present disclosure is not strictly limited to the described workflows and steps. Steps described as sequential may be executed in parallel, order of steps may be varied, and steps may be modified, combined, added, or omitted. As another example, although certain embodiments may have been described using a particular combination of hardware and software, it should be recognized that other combinations of hardware and software are possible, and that specific operations described as being implemented in hardware can also be implemented in software and vice versa.

The specification and drawings are, accordingly, to be regarded in an illustrative rather than restrictive sense. Other arrangements, embodiments, implementations, and equivalents will be evident to those skilled in the art and may be employed without departing from the spirit and scope of the present disclosure as set forth in the following claims.

1. A method performed by a network device that implements Border Gateway Protocol (BGP), the method comprising:
identifying a BGP route to be advertised to an outbound BGP peer of the network device;
determining one or more inbound peer tags associated with an inbound BGP peer from which the BGP route was received;
determining one or more outbound peer tags associated with the outbound BGP peer;
performing one or more comparisons between the one or more inbound peer tags and the one or more outbound peer tags; and
based on the one or more comparisons, allowing the BGP route to be advertised to the outbound BGP peer or denying the BGP route from being advertised to the outbound BGP peer.

2. The method of claim 1 wherein the one or more inbound peer tags and the one or more outbound peer tags are assigned by a user or administrator of the network device.

3. The method of claim 1 wherein the one or more comparisons are defined in a peer tag filtering policy that is configured with respect to the outbound BGP peer.

4. The method of claim 1 wherein the method is performed in a BGP control plane of the network device during outbound BGP route advertisement processing.

5. The method of claim 4 wherein the method is performed prior to processing outbound route policies during the outbound BGP route advertisement processing.

6. The method of claim 1 wherein the one or more comparisons include checking whether the one or more inbound peer tags are identical to the one or more outbound peer tags.

7. The method of claim 6 wherein the BGP route is allowed to be advertised to the outbound BGP peer upon determining that the one or more inbound peer tags are identical to the one or more outbound peer tags, and wherein the BGP route is denied from being advertised to the outbound BGP peer upon determining that the one or more inbound peer tags are different from the one or more outbound peer tags.

8. The method of claim 6 wherein the BGP route is denied from being advertised to the outbound BGP peer upon determining that the one or more inbound peer tags are identical to the one or more outbound peer tags, and wherein the BGP route is allowed to be advertised to the outbound BGP peer upon determining that the one or more inbound peer tags are different from the one or more outbound peer tags.

9. The method of claim 1 wherein the network device is a leaf or a spine in a leaf-spine network and wherein the outbound BGP peer is an external BGP (eBGP) peer of the network device.

10. A network device that implements Border Gateway Protocol (BGP), the network device comprising:
a central processing unit (CPU); and
a main memory having stored thereon program code that, when executed by the CPU, causes the CPU to:
identify a BGP route to be advertised to an outbound BGP peer of the network device;
determine one or more inbound peer tags associated with an inbound BGP peer from which the BGP route was received;
determine one or more outbound peer tags associated with the outbound BGP peer;
perform one or more comparisons between the one or more inbound peer tags and the one or more outbound peer tags; and
based on the one or more comparisons, allow the BGP route to be advertised to the outbound BGP peer or deny the BGP route from being advertised to the outbound BGP peer.

11. The network device of claim 10 wherein the one or more inbound peer tags and the one or more outbound peer tags are assigned by a user or administrator of the network device.

12. The network device of claim 10 wherein the one or more comparisons are defined in a peer tag filtering policy that is configured with respect to the outbound BGP peer.

13. The network device of claim 10 wherein the program code is part of an outbound BGP route advertisement processing task performed in a BGP control plane of the network device.

14. The network device of claim 13 wherein the program code is executed prior to processing outbound route policies during the outbound BGP route advertisement processing task.

15. The network device of claim 10 wherein the one or more comparisons include checking whether the one or more inbound peer tags are identical to the one or more outbound peer tags.

16. The network device of claim 15 wherein the BGP route is allowed to be advertised to the outbound BGP peer upon determining that the one or more inbound peer tags are identical to the one or more outbound peer tags, and wherein the BGP route is denied from being advertised to the outbound BGP peer upon determining that the one or more inbound peer tags are different from the one or more outbound peer tags.

17. The network device of claim 15 wherein the BGP route is denied from being advertised to the outbound BGP peer upon determining that the one or more inbound peer tags are identical to the one or more outbound peer tags, and wherein the BGP route is allowed to be advertised to the outbound BGP peer upon determining that the one or more inbound peer tags are different from the one or more outbound peer tags.

18. The network device of claim 10 wherein the network device is a leaf or a spine in a leaf-spine network and wherein the outbound BGP peer is an external BGP (eBGP) peer of the network device.

19. A method performed by a network device that implements Border Gateway Protocol (BGP), the method comprising:
receiving assignments of peer tags to BGP peers of the network device; and
during outbound BGP route advertisement processing, filtering outbound BGP routes based on the assigned peer tags.

20. The method of claim 19 wherein the filtering comprises, for an outbound BGP route:
determining one or more first peer tags assigned to a first BGP peer from which the BGP route was received;
determining one or more second peer tags assigned to a second BGP peer to which the BGP route is targeted to be sent; and
comparing the one or more first peer tags and the one or more second peer tags.
